(19) United States
(12) Patent Application Publication
(10) Pub. No.: US 2026/0236622 A1
(43) Pub. Date: Aug. 13, 2026

(54) LOCK CIRCUIT AND METHOD FOR UNLOCKING A DEVICE

(71) Applicant: ams-OSRAM AG, Premstaetten (AT)

(72) Inventors: Vasanth Swaroop YADAGIRI, Frisco, TX (US); Robert VAN ZEELAND, Frisco, TX (US)

(21) Appl. No.: 19/160,487

(22) PCT Filed: Feb. 12, 2024
(86) PCT No.: PCT/EP2024/053455

§ 371 Date: Aug. 28, 2025

Related U.S. Application Data
(60) Provisional application No. 63/489,219, filed on Mar. 9, 2023.

(51) Int. Cl. G06F 21/74; G06F 21/75; G06F 21/76

(52) U.S. Cl. CPC G06F 21/74; G06F 21/75; G06F 21/76

(57) ABSTRACT

A lock circuit includes an input pin, a comparator arrangement, and a latching logic. The input pin is configured to receive an input signal. The comparator arrangement includes a first input coupled to the input pin and a comparator output. The latching logic includes a data input coupled to the comparator output and a latch output. Moreover, a method for unlocking a device is provided.

This patent application is the national stage entry of International Patent Application No. PCT/EP2024/053455, filed on Feb. 12, 2024, which claims the priority of U.S. patent application 63/489,219, filed on Mar. 9, 2023, the disclosure contents of both of which are hereby incorporated by reference.

### TECHNICAL FIELD

A lock circuit and a method for unlocking a device are provided.

### BACKGROUND

In current devices test modes, debug and design for analysis, type registers and other advanced configuration space are often secured using a software programmable password. This approach can cause an unwanted and/or detrimental behavior of a device in an application. The device may be vulnerable to malicious attacks and could be hacked.

### SUMMARY

An object of the present application is to overcome the above-mentioned vulnerability while, e.g., keeping the impact on test, using an automatic test equipment (abbreviated ATE) and bench validation, time and complexity minimal.

It is an object of the present application to provide a lock circuit and a method for unlocking a device which increase a safety of an access to a device.

This object is achieved by the subject-matter of the independent claims. Further embodiments and developments are given in the dependent claims.

In an embodiment, a lock circuit comprises an input pin, a comparator arrangement and a latching logic. The input pin is configured to receive an input signal. The comparator arrangement comprises a first input coupled to the input pin. The latching logic comprises a latch output and a data input coupled to a comparator output of the comparator arrangement.

Advantageously, a latch output signal of the latch depends on the input signal. Only an input signal which has a predetermined value or predetermined values is able to generate a latch output signal that allows an access to a device. The lock circuit improves a security of the device that incorporates the lock circuit. The lock circuit realizes a hardware enabled and software fool-proof security.

In an embodiment of the lock circuit, the comparator arrangement is configured to generate a comparator output signal at the comparator output
with a first logical value in case the input signal fulfills a predetermined criterion and
with a second logical value in case the input signal does not fulfill or deviates from the predetermined criterion.

In an embodiment of the lock circuit, the comparator arrangement comprises a second input configured to receive a reference signal.

In an embodiment of the lock circuit, the comparator arrangement is configured to compare the input signal and the reference signal and to generate the comparator output signal as a function of the comparison.

In an embodiment of the lock circuit, the comparator arrangement is configured to generate the comparator output signal with the first logical value in case the input signal has an higher value or an equal value in comparison to the reference signal and with the second logical value in case the input signal has a lower value than the reference signal.

In an embodiment of the lock circuit, the input signal is implemented as a voltage or a current. The input signal is implemented as a signal of a group consisting of a DC voltage (DC is the abbreviation for direct current), a DC current, an AC voltage (AC is the abbreviation for alternating current) and an AC current.

In an example, the reference signal is implemented such as the input signal. Thus, the input signal and the reference signal are e.g. both implemented as DC voltages or both implemented as DC currents. In case the input signal is an AC voltage, the reference signal is e.g. a DC voltage. In case the input signal is an AC current, the reference signal is e.g. a DC current.

In an embodiment of the lock circuit, the comparator arrangement is configured to generate the comparator output signal with the first logical value in case the input signal has a lower value or an equal value in comparison to the reference signal and with the second logical value in case the input signal has a higher value than the reference signal.

In an embodiment of the lock circuit, the comparator arrangement is configured to generate the comparator output signal with the first logical value in case the input signal has a value in a first range between the reference signal and a further reference signal and with the second logical value in case the input signal has a value outside of the first range.

In an embodiment of the lock circuit, an input signal having a voltage value configured to generate the comparator output signal with the first logical value is not a value that corresponds to a low level or a high level of a digital circuit. For example, in a CMOS digital circuit with a supply voltage of 5 V, the low level is e.g. in a range between 0 V and 1.5 V and the high level is e.g. in a range between 3.5 V and 5.0 V. Alternatively, the low level is e.g. in a range between 0 V and 20% of a supply voltage and the high level is e.g. in a range between 80% of the supply voltage and the supply voltage.

In an embodiment of the lock circuit, the comparator arrangement is configured to generate the comparator output signal with the first logical value for an input signal which is outside of the voltage range for the low level and outside of the voltage range of the high level. Thus, in an example, the reference signal has a voltage value equal or below the reference potential or ground potential or a voltage value equal or higher than the supply voltage. In an alternative example, the first range between the reference signal and the further reference signal is in a voltage range above the voltage range for the low level and below the voltage range of the high level. Thus, the input pin and the comparator arrangement are not realized e.g. as a typical enable pin and an input circuit for receiving and recognizing a low level voltage and a high level voltage of a digital signal.

In an embodiment of the lock circuit, the latching logic is configured to provide a latch output signal at the latch output with a first logical value in case the comparator output signal or a signal derived from the comparator output signal has a first logical value or had a first logical value before.

In an embodiment of the lock circuit, the latching logic comprises a reset input configured to receive a reset signal.

In an embodiment of the lock circuit, the latching logic is configured to provide the latch output signal with a second logical value in case the comparator output signal or the signal derived from the comparator output signal has the second logical value or the latching logic receives or had received the reset signal with a value configured for reset of the latching logic.

In an embodiment, the lock circuit comprises a synchronizer logic having a data input coupled to the comparator output and a data output coupled to the data input of the latching logic.

In an embodiment, the lock circuit comprises a memory and a combining logic. The combining logic comprises a first input coupled to the latch output, a second input coupled to the memory, and a circuit output configured to provide an unlock signal. The unlock signal allows or disables an access to a circuit part that is connected to the lock circuit.

In an embodiment of the lock circuit, the memory is realized as a one-time programmable memory (abbreviated OTP) or a non-volatile memory (abbreviated NVM). The OTP is realized e.g. as a fuse. In case the fuse is burnt, the unlock signal has a logical value configured for locking.

In an embodiment of the lock circuit, the memory is configured to store a first or a second logical value. The first logical value can be switched into the second logical value and the second logical value cannot be switched into the first logical value. The first logical value is switchable into the second logical value and the second logical value is not switchable into the first logical value—In an example, the memory is a one-bit memory.

In an embodiment, the lock circuit comprises a memory latch having a terminal coupled to the memory and an output coupled to the second input of the combining logic.

In an embodiment of the lock circuit, the combining logic is configured to generate the unlock signal with a logical value configured for unlocking only in case the memory stores the first logical value and/or the latch output signal has the first logical value. Thus, one condition of the above mentioned two conditions has to be fulfilled to generate the unlock signal with the logical value configured for unlocking.

In an example, the first logical value of the memory is 0 and the second logical value of the memory is 1. In an example, the first logical value of the latch output signal is 1 and the second logical value of the latch output signal is 0. When the memory stores the first logical value (say 0), then the combining logic generates the unlock signal with a logical value configured for unlocking and this state does not depend on the latch output signal. When the memory is switched to the second logical value (say 1), then the combining logic generates the unlock signal with a logical value configured for unlocking only when the latch output signal has the first logical value (say 1).

In an embodiment of the lock circuit, the combining logic is configured to generate the unlock signal with a logical value configured for locking in case the memory stores the second logical value and the latch output signal has the second logical value. Thus, both conditions of the above mentioned conditions have to be fulfilled to generate the unlock signal with the logical value configured for locking. When the memory is switched to the second logical value (say 1) and the latch output signal obtains the second logical value (say 0), the combining logic is configured to generate the unlock signal with the logical value configured for locking.

In an embodiment, a method for unlocking a device comprises
applying an input signal to an input pin,
generating a comparator output signal by a comparator arrangement as a function of the input signal, and
generating a latch output signal by a latching logic as a function of the comparator output signal or of a signal derived from the comparator output signal.

The lock circuit is particularly suitable for the method for unlocking a device. Features described in connection with the lock circuit can therefore be used for the method and vice versa.

In an example, the lock circuit is configured for OTP or NVM enabled hardware based security for an integrated circuit (abbreviated IC). The lock circuit is e.g. part of a product which requires hardware based security and tamper protection against accidental and/or malicious attacks.

In an example, the lock circuit improves a hardware based security for ICs. A NVM or OTP based enable is performed at factory. The lock circuit implements a 2-step protection, namely uses both software and hardware. A protection against unwanted or unwarranted device access is achieved. The lock circuit comprises an on-chip analog comparator attached on a physical pin.

In an example, the lock circuit provides a hardware based security against any accidental or unauthorized/malicious device access. The lock circuit is implemented within the device itself with minimal overhead, utilizes the existing reference voltages/resources and does not require an additional device for providing security. The lock circuit implements a hardware based protection which makes it immune to a brute force software hack/attack. By the virtue of its implementation the lock circuit performs a 2-step protection.

In an example, the lock circuit does not always lock out the internals from being accessed, instead provides the option to enable the security feature by an OTP or NVM bit at the factory or field. This provides the flexibility to perform testing on ATE and bench setup without additional time and complexity. Once enabled it uses a hardware intervention to apply a specific voltage on a physical pin to unlock access to the protected space in the device. The hardware unlock feature prevents a software attack and consequently protects the critical configuration and functions of the device. This is advantageous e.g. in customer applications.

### BRIEF DESCRIPTION OF THE DRAWINGS

The following description of figures of examples or embodiments may further illustrate and explain aspects of the lock circuit and the method for unlocking a device. Arrangements, devices and circuit blocks with the same structure and the same effect, respectively, appear with equivalent reference symbols. In so far as arrangements, devices and circuit blocks correspond to one another in terms of their function in different figures, the description thereof is not repeated for each of the following figures.

FIGS. 1A and 1B show exemplary embodiments of a device with a lock circuit;

FIG. 2 shows an exemplary embodiment of a method for unlocking a device; and

FIG. 3 shows an exemplary embodiment of the conditions for locking and unlocking.

### DETAILED DESCRIPTION

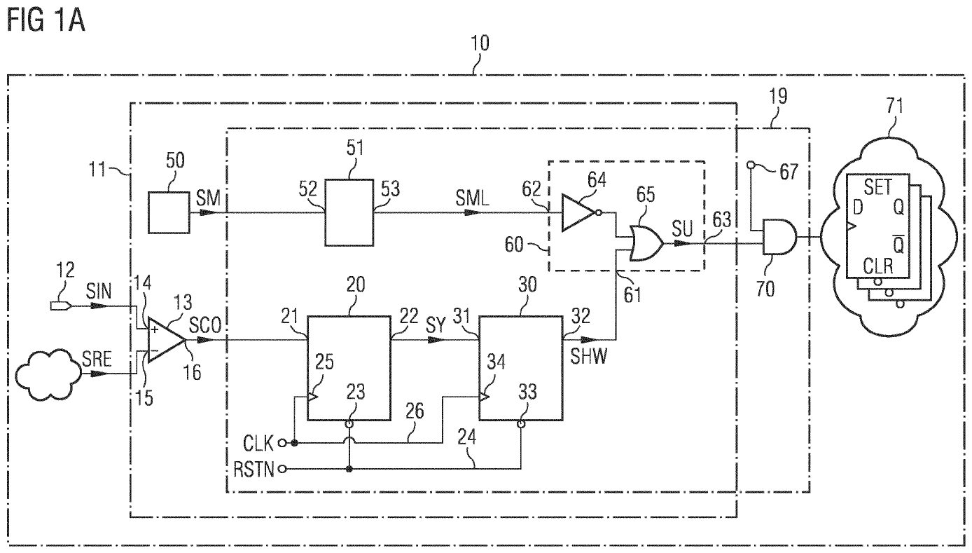

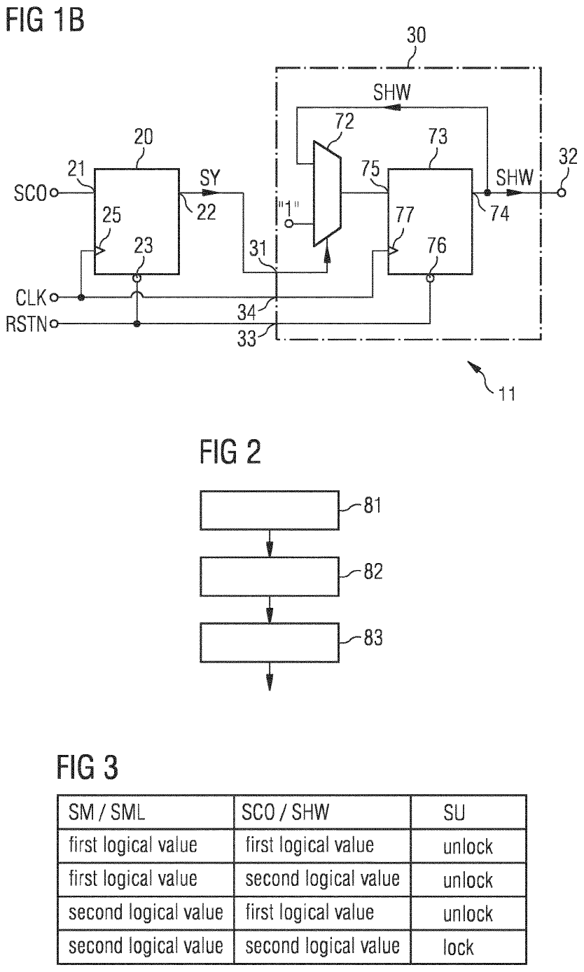

FIG. 1A shows an exemplary embodiment of a device 10 with a lock circuit 11. In FIG. 1, a concept block diagram is illustrated. The lock circuit 11 comprises an input pin 12 and a comparator arrangement 13 with a first input 14 connected or coupled to the input pin 12, with a second input 15 and with a comparator output 16. In an example, the input pin 12 is directly and permanently connected to the first input 14 of the comparator arrangement 13. Optionally, a reference source (not shown) is connected or coupled to the second input 15 of the comparator arrangement 13. The input pin 12 can be named hardware protect test pin. The comparator arrangement 13 is realized as an analog comparator logic. The comparator output 16 can be named hardware protect comparator output.

The lock circuit 11 comprises a latching logic 30 with a data input 31 coupled to the comparator output 16 and with a latch output 32. The latching logic 30 comprises a reset input 33.

The lock circuit 11 comprises a synchronizer logic 20 having a data input 21 connected or coupled to the comparator output 16 and a data output 22 connected or coupled to the data input 31 of the latching logic 30. The synchronizer logic 20 comprises a reset input 23.

The lock circuit 11 comprises a reset line 24 that is connected or coupled to the reset input 33 of the latching logic 30 and to the reset input 23 of the synchronizer logic 20. The lock circuit 11 comprises a clock line 26 which is connected or coupled to a clock input 34 of the latching logic 30 and to a clock input 25 of the synchronizer logic 20.

The lock circuit 11 comprises a memory 50 and a combining logic 60. The combining logic 60 comprises a first input 61 connected or coupled to the latch output 32, a second input 62 connected or coupled to the memory 50, and a circuit output 63 configured to provide an unlock signal SU. For example, the combining logic 60 comprises a gate 65 with a first and a second input coupled to the first and the second input 61, 62 of the combining logic 60. An output of the gate 65 is connected or coupled to the circuit output 63. The gate 65 is implemented e.g. as an OR gate. The gate 65 has e.g. the functionality of an OR gate. For example, an inverter 64 couples the second input 62 of the combining logic 60 to a second input of the gate 65.

The lock circuit 11 comprises a memory latch 51 having a terminal 52 connected or coupled to the memory 50 and an output 53 connected or coupled to the second input 62 of the combining logic 60. For example, the memory latch 51 comprises a latch and a hardware-protect self-test logic.

The device 10 comprises a logic gate 70 with a first input coupled or connected to the circuit output 63. A second input of the logic gate 70 is connected or coupled to an input terminal 67 of the device 10. The input terminal 67 is realized e.g. as write access to a secure space. The logic gate 70 is e.g. implemented as an AND gate. The logic gate 70 has e.g. the functionality of an AND gate.

The device 10 comprises a circuit part 71 that is connected or coupled to an output of the logic gate 70. The circuit part 71 is a protected space or secure space.

The memory 50 is realized as a one-time programmable memory (abbreviated OTP) and/or a non-volatile memory (abbreviated NVM). The OTP is implemented e.g. as a fuse.

The lock circuit 11 comprises a digital logic 19 which comprises the synchronizer logic 20, the latching logic 30, the memory latch 51, the combining logic 60 and the logic gate 70.

An input signal SIN is applied to the input pin 12. The comparator arrangement 13 generates a comparator output signal SCO at the comparator output 16 with a first logical value in case the input signal SIN fulfills a predetermined criterion and with a second logical value in case the input signal SIN deviates from the predetermined criterion.

A reference signal SRE is applied to the second input 15 of the comparator arrangement 13. The comparator arrangement 13 compares the input signal SIN and the reference signal SRE and generates the comparator output signal SCO as a function of the comparison.

In an example, the comparator arrangement 13 generates the comparator output signal SCO. The comparator output signal SCO has a first logical value in case the input signal SIN has a higher voltage value or an equal voltage value in comparison to the reference signal SRE. The comparator output signal SCO has a second logical value in case the input signal SIN has a lower voltage value than the reference signal SRE. The comparator arrangement 13 is realized e.g. as a single comparator 13.

In an alternative embodiment, the comparator arrangement 13 generates the comparator output signal SCO with the first logical value in case the input signal SIN has a lower voltage value or an equal voltage value in comparison to the reference signal SRE and with the second logical value in case the input signal SIN has a higher voltage value than the reference signal SRE.

In an alternative embodiment, a further reference signal (not shown) is applied to the comparator arrangement 13. The comparator arrangement 13 generates the comparator output signal SCO with the first logical value in case the input signal SIN has a voltage value in a first range between the reference signal SRE and the further reference signal and with the second logical value in case the input signal SIN has a voltage value outside of the first range. The comparator arrangement 13 is realized as a window comparator.

The synchronizer logic 20 generates a signal SY as a function of the comparator output signal SCO. Thus, the signal SY is derived from the comparator output signal SCO. The latching logic 30 provides a latch output signal SHW at the latch output 32 with a first logical value in case the comparator output signal SCO or the signal SY had a first logical value before. The latch output signal SHW can also be named hardware unlock signal.

A reset signal RSTN is applied to the reset input 33 of the latching logic 30. The latching logic 30 is configured to provide the latch output signal SHW with a second logical value in case the comparator output signal SCO or the signal SY derived from the comparator output signal SCO has the second logical value or the latching logic 30 had received the reset signal RSTN with a value configured for reset of the latching logic 30.

The combining logic 60 provides an unlock signal SU at the circuit output 63.

The memory 50 is configured to store a first or a second logical value. The memory 50 is configured that the first logical value can be switched into the second logical value and the second logical value cannot be switched into the first logical value. The memory 50 generates a memory signal SM that can be named e.g. hardware protect lock signal. The memory latch 51 generates a memory latch signal SML which is a function of the information stored by the memory 50. The memory latch signal SML is realized e.g. as hardware protect lock enable signal.

The combining logic 60 generates the unlock signal SU with a logical value configured for unlocking if the memory 50 stores the first logical value (e.g. 0), irrespective of the latch output signal SHW. When the memory 50 is switched to the second logical value (e.g. 1), then the combining logic 60 generates the unlock signal SU with a logical value configured for unlocking only when the latch output signal SHW has the first logical value (e.g. 1).

The combining logic 60 generates the unlock signal SU with a logical value configured for locking, if the memory 50 stores the second logical value and if the latch output signal SHW has the second logical value. In other words, when the memory 50 is switched to the second logical value (say 1), the latching logic 30 has to provide the first logical value (say 1) to unlock; if the latching logic 30 provides the second logical value (say 0), the unlock signal SU is configured with a logical value for locking.

The lock circuit realizes an OTP or NVM enabled hardware security.

The device 10 is realized e.g. as an application specific integrated circuit, abbreviated ASIC. The device 10 implements hardware based security to protect unauthorized access to internal space, features or functions. For example, the device 10 is fabricated on exactly one semiconductor body. The device 10 is realized e.g. as a single chip or single die.

FIG. 1B shows an exemplary embodiment of details of a lock circuit 11 which is a further development of the embodiment shown in FIG. 1A. The latching logic 30 comprises a multiplexer 72 and a flip-flop 73. A first input of the multiplexer 72 is connected to a data output 74 of the flip-flop 73. A constant value is applied to a second input of the multiplexer 72. The constant value is e.g. equal to the second logical value of the comparator output signal SCO (e.g. 1). The data output 22 of the synchronizer logic 20 is connected to a control terminal of the multiplexer 72. An output of the multiplexer 72 is connected to a data input 75 of the flip-flop 73. The reset line 33 is connected to a reset input 76 of the flip-flop 73. The clock line 34 is connected to a clock input 77 of the flip-flop 73. The flip-flop 73 is implemented e.g. as RS flip-flop. The data output 74 of the flip-flop 73 is connected to the latch output 32 of the latching logic 30. The flip-flop 73 generates the latch output signal SHW and provides the latch output signal SHW at the latch output 32.

The latching logic 30 is configured to hold the value of the comparator output signal SCO when the latching logic 30 is triggered. For example, if the comparator output signal SCO has the first logical value (e.g. 1), when SIN>SRE (predetermined condition), then the latching logic 30 will latch the first logical value until reset by the reset signal RSTN. After this, if the input signal SIN falls below the reference signal SRE (SIN<SRE), then the comparator output signal SCO will become the second logical value (e.g. 0), but the data signal SHW at the output of the latching logic 30 will stay latched at 1 until reset.

FIG. 2 shows an exemplary embodiment of a method for unlocking a device which is a further development of the embodiment shown in FIGS. 1A and 1B. The method for unlocking a device is particularly suitable for the device 10 and the lock circuit 11 of FIG. 1. The method for unlocking the device 10 comprises at least the following blocks or step sequences:
First block 81: The input signal SIN is applied to the input pin 12.
Second block 82: The comparator output signal SCO is generated by the comparator arrangement 13 as a function of the input signal SIN.
Third block 83: The latch output signal SHW is generated by the latching logic 30 as a function of the comparator output signal SCO or of the signal SY derived from the comparator output signal SCO.

The lock circuit and the method implement a NVM/OTP enabled (for factory testing), hack-proof, hardware based security to protect a programmable space and/or functions of the device 10 from accidental/intentional malicious attacks.

The lock circuit 11 realizes an on-chip hardware-based protection. The lock circuit 11 uses an existing on chip voltage reference for generating the reference signal SRE. The lock circuit 11 can be fabricated with minimal design/circuit overhead. An OTP or NVM bit is used to enable the security feature when required. The lock circuit 11 can be implemented for any process node and application. A 2-step protection using software and hardware is performed.

The hardware protected (abbreviated HP) lock feature secures a selected set or all registers/features/functions from an unwarranted, unauthorized, accidental or malicious access to the critical parts of the device 10. The access to the HP protected space is enabled (unlocked) only by a sequence of operations which includes a hardware step where an application specific voltage is applied on a physical pin 12. The hardware unlock logic is implemented by using an analog comparator arrangement 13 on a physical input pin 12 of the device 10 along with the downstream digital logic 19.

First the comparator arrangement 13 is enabled. The comparator enable is done e.g. by a software command and is optionally protected by using a software password scheme. The reference voltage for the comparator is specified by the application and is derived e.g. from an existing circuit. The comparator arrangement 13 comprises one or more comparators (depending on the application) to detect the voltage or voltage range on the physical input pin 12. The output of the comparator arrangement 13 is connected to the digital logic 19.

When the application specific voltage is applied to the input pin 12, the comparator output signal SCO is triggered. The digital logic 19 detects the comparator output signal SCO, latches the comparator output signal SCO and enables the access to the HP space 71 of the device 10.

The latching logic 30 in digital holds the state of the comparator arrangement 13 until reset, hence the application specific voltage need not be constantly applied on the input pin 12 to keep the protected access open. This feature helps releasing the physical pin (after the hardware unlock is done) to be used for any other test or functional purpose. The OTP/NVM latch and self-test logic 51 samples and latches the OTP or NVM bit value on every power up into a read only memory. This eliminates the possibility of a software trying to quasi modify the content in the OTP and gain access to the protected space. The self-test logic provides an option to test the hardware security circuit itself.

The output of the above mentioned HP unlock logic is gated with an OTP or NVM bit which can be named a hardware protected lock bit, abbreviated HP_LOCK. Hence, together with the software protection to enable the comparator arrangement 13 and the actual hardware protection, a 2-step security is provided by the lock circuit 11.

In an example, when the memory signal SM (also named HP_LOCK) is 0 (disabled), the HP unlock logic is ineffective/bypassed, thus providing unrestricted access to the protected space. These steps are intended for a factory mode of operation.

When the memory signal SM is 1 (enabled), the HP unlock logic is active and blocks access to the protected space of the device 10. This steps are intended for an actual application. The memory 50 (also named HP_LOCK bit) can be programmed when required. For example, the memory 50 is programmed at the factory.

FIG. 3 shows an exemplary embodiment of the conditions for locking and unlocking of an embodiment of a device 10 with a lock circuit 11 as described above. The unlock signal SU depends on the memory latch signal SML and on the latch output signal SHW, e.g. as shown in the table of FIG. 3. The memory latch signal SML depends on the memory signal SM. The latch output signal SHW depends on the comparator output signal SCO. “unlock” means that the unlock signal SU has the logical value configured for unlocking. “lock” means that the unlock signal SU has the logical value configured for locking. The memory signal SM can only be changed from the first to the second logical value (e.g. by burning a fuse). The comparator output signal SCO has the first logical value when the input signal SIN fulfills the criterion (e.g. SIN≥SRE) ; otherwise the comparator output signal SCO has the second logical value.

In an alternative, not shown embodiment, the unlock signal SU has another dependency from the memory latch signal SML and the latch output signal SHW. For example, the unlock signal SU has the logical value configured for unlocking only in case both the memory latch signal SML and the latch output signal SHW have the first logical value; in this example, the unlock signal SU has the logical value configured for locking in case at least one of the memory latch signal SML and the latch output signal SHW have the second logical value.

The invention is not limited to the description of the embodiments. Rather, the invention comprises each new feature as well as each combination of features, particularly each combination of features of the claims, even if the feature or the combination of features itself is not explicitly given in the claims or embodiments.

1. A lock circuit, comprising:
an input pin configured to receive an input signal,
a comparator arrangement with a first input coupled to the input pin and with a comparator output, and
a latching logic with a data input coupled to the comparator output and with a latch output.

2. The lock circuit of claim 1,
wherein the comparator arrangement is configured to generate a comparator output signal at the comparator output
with a first logical value in case the input signal fulfills a predetermined criterion and
with a second logical value in case the input signal deviates from the predetermined criterion.

3. The lock circuit of claim 2,
wherein the comparator arrangement comprises a second input configured to receive a reference signal, and
wherein the comparator arrangement is configured to compare the input signal and the reference signal and to generate the comparator output signal as a function of the comparison.

4. The lock circuit of claim 3,
wherein the comparator arrangement is configured to generate the comparator output signal with the first logical value in case the input signal has an higher value or an equal value in comparison to the reference signal and with the second logical value in case the input signal has a lower value than the reference signal.

5. The lock circuit of claim 3,
wherein the comparator arrangement is configured to generate the comparator output signal with
the first logical value in case the input signal has a lower value or an equal value in comparison to the reference signal and with the second logical value in case the input signal has a higher value than the reference signal.

6. The lock circuit of claim 3,
wherein the comparator arrangement is configured to generate the comparator output signal with the first logical value in case the input signal has a value in a first range between the reference signal and a further reference signal and with the second logical value in case the input signal has a value outside of the first range.

7. The lock circuit of claim 2,
wherein the latching logic is configured to provide a latch output signal at the latch output with a first logical value in case the comparator output signal or the signal derived from the comparator output signal has the first logical value.

8. The lock circuit of claim 2,
wherein the latching logic comprises a reset input configured to receive a reset signal,
the latching logic is configured to provide the latch output signal with a second logical value in case
the comparator output signal or a signal derived from the comparator output signal has the second logical value or
the latching logic had received the reset signal with a value configured for reset of the latching logic.

9. The lock circuit of claim 1,
wherein the lock circuit comprises a synchronizer logic having a data input coupled to the comparator output and a data output coupled to the data input of the latching logic.

10. The lock circuit of claim 1,
wherein the lock circuit comprises a memory and a combining logic with
a first input coupled to the latch output,
a second input coupled to the memory, and
a circuit output configured to provide an unlock signal.

11. The lock circuit of claim 10,
wherein the memory is realized as a one-time programmable memory and/or a non-volatile memory.

12. The lock circuit of claim 10,
wherein the memory is configured to store a first or a second logical value, wherein the first logical value can be switched into the second logical value and the second logical value cannot be switched into the first logical value.

13. The lock circuit of claim 10,
wherein the lock circuit comprises a memory latch having a terminal coupled to the memory and an output coupled to the second input of the combining logic.

14. The lock circuit of claim 10,
wherein the combining logic is configured to generate the unlock signal with a logical value configured for unlocking in case the memory stores the first logical value.

15. The lock circuit of claim 10,
wherein the combining logic is configured to generate the unlock signal with a logical value configured for unlocking in case the latch output signal has the first logical value.

16. The lock circuit of claim 10,
wherein the combining logic is configured to generate the unlock signal with a logical value configured for locking
in case the memory stores the second logical value and
in case the latch output signal has the second value.

17. A method for unlocking a device, comprising:
applying an input signal to an input pin,
generating a comparator output signal by a comparator arrangement as a function of the input signal, and
generating a latch output signal by a latching logic as a function of the comparator output signal or of a signal derived from the comparator output signal.

18. The method of claim 17,
wherein the method further comprises:
generating a memory latch signal which is a function of information stored by a memory,
providing an unlock signal by a combining logic, wherein the unlock signal depends on the memory latch signal and on a latch output signal.

19. A lock circuit, comprising:
an input pin configured to receive an input signal,
a comparator arrangement with a first input coupled to the input pin and with a comparator output,
a latching logic with a data input coupled to the comparator output and with a latch output,
a memory, and
a combining logic with a first input coupled to the latch output, a second input coupled to the memory, and a circuit output configured to provide an unlock signal.
